(19) United States
(12) Patent Application Publication
(10) Pub. No.: US 2004/0143625 A1
(43) Pub. Date: Jul. 22, 2004

(54) Component proxy with interception logic in remote component container

(76) Inventors: Joseph Sheinis, Toronto (CA); Ming Chan, Toronto (CA)

Correspondence Address: Robert C. Kowert, P.O. Box 398, Austin, TX, 78767, US

(21) Appl. No.: 10/319,126

(22) Filed: Dec. 13, 2002

(51) Int. Cl. G06F 15/16

(52) U.S. Cl. 709/202

(57) ABSTRACT

Interception logic may be configured to intercept remote calls to an application component and invoke concern-specific logic in response to an intercepted remote call to the application component. The application component may be configured to run within a component container. The component container may be configured to provide standard services to application components. The concern-specific logic may be configured separate from the application component to provide a service that is not included as a standard service of the component container. A container-side proxy may be configured to receive one or more remote calls to the application component for interception by the concern-specific logic. A client-side proxy may be configured to receive one or more of the remote calls originated by the client component for interception by client-side concern-specific logic. The client-side proxy may also be configured to forward the one or more remote calls to the container-side proxy.

### BACKGROUND

1. Field of the Invention

This invention relates to computer systems, and more particularly to interception of client requests to remote components of an application in order to provide concern-specific logic for the application.

2. Description of the Related Art

Distributed applications are often implemented as part of commercial and non-commercial business solutions for an enterprise. For example, a company may leverage use of an enterprise application that includes various databases distributed across multiple computers. The enterprise application may be mission-critical (e.g., users of the enterprise application may rely heavily on critical data maintained by the application and may expect the application to be highly available). Security, transaction management, state management and multi-threading are exemplary concerns that may be important considerations in the development of the mission-critical enterprise application.

Various obstacles relating to these concerns may be encountered during implementation of an enterprise application. For example, although application container or server products typically provide common concern-specific logic for use by applications, some concern-specific logic may not be supported or may be supported in a limited manner. Concern-specific logic for common services (e.g., security, state management, etc.) may be delegated to containers and/or servers in which the application components execute. For example, containers may provide application programming interfaces for common services that application components use to access the services. If concern-specific logic (as provided by the container) does not satisfy the requirements for an application, the concern-specific logic is typically implemented by adding additional logic for the specific concern into each application component. Adding the additional logic may introduce unnecessary complexity (e.g., additional development, additional testing, additional maintenance) that may lead to an increase in development and/or maintenance time.

A particular container product such as an Enterprise JavaBeans™ (EJB™) container, for example, may impose constraints on implementation of an enterprise application because some concern-specific logic may not be supported or may be supported in a limited manner. A role-based security model, such as the one provided for Enterprise JavaBeans, may not provide standard support for logging, entity-based access control or other specific concerns. Thus, concern-specific logic not supported as a standard in an EJB-based application container is typically implemented by adding concern-specific logic for the specific concern into each EJB component.

It may also be desirable to provide concern-specific logic on either the client-side (e.g., client Java Virtual Machine) or the container-side (e.g., within an EJB container). Access control rules and data, for example, are typically located on a server and thus an application developer may want to specify that entity-based access control logic be executed on the server.

### SUMMARY

Interception logic may be configured to intercept remote calls to an application component and invoke concern-specific logic in response to an intercepted remote call to the application component. The application component may be configured to run within a component container. The component container may be configured to provide standard services to application components. In one embodiment, the interception logic may include a container-side proxy for the application component that may be configured to run within the component container. The concern-specific logic may be configured separate from the application component to provide a service that is not included as a standard service of the component container. The container-side proxy for the application component may be configured to receive one or more remote calls to the application component for interception by the concern-specific logic.

A client component may be configured to originate remote calls to the application component. In one embodiment, the interception logic may include a client-side proxy configured to receive one or more of the remote calls originated by the client component for interception by client-side concern-specific logic. The client-side proxy may also be configured to forward the one or more remote calls to the container-side proxy. The client-side proxy may maintain a reference to the container-side proxy. The client-side proxy may appear to the client component as the remote interface of the application component.

In one embodiment, the interception logic may also include a service locator. The service locator may be configured to return the client-side proxy to the client component in response to a call from the client component for a remote interface to the application component. The container-side proxy may be further configured to forward the remote calls to the application component. In one embodiment, the client component may execute on a Java Virtual Machine and the application component may execute on a different Java Virtual Machine than the client component. The component container may be an Enterprise JavaBeans component container and the application component may be developed as an Enterprise JavaBean.

In one embodiment, the concern-specific logic may be registered as a method invocation listener to receive remote method invocations for the application component. In one embodiment, the concern-specific logic may be configured to provide authorization-based access control for the application component and to generate an exception if any access control rules are violated.

### BRIEF DESCRIPTION OF THE DRAWINGS

FIG. 1 illustrates a three-tier architecture of a computer system, suitable for implementing various embodiments;

FIG. 2 illustrates one embodiment of interception logic configured to intercept remote calls to an application component and invoke concern-specific logic in response to an intercepted remote call;

FIG. 3 shows a flowchart of one embodiment of a method for intercepting remote calls to an application component and invoking concern-specific logic on the client-side in response to an intercepted remote call to the application component;

FIG. 4 shows a flowchart of one embodiment of a method for intercepting remote calls to an application component and invoking concern-specific logic on the container-side in response to an intercepted remote call to the application component;

FIG. 5 illustrates one embodiment of interception logic including a service locator, a client-side proxy and a container-side proxy;

FIG. 6 shows a flowchart of one embodiment of a method for intercepting remote calls to an application component and invoking concern-specific logic in response to an intercepted remote call to the application component; and

FIG. 7 illustrates a computer system that may include one embodiment of interception logic configured to intercept remote calls to an application component and invoke concern-specific logic in response to an intercepted remote call to the application component;

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

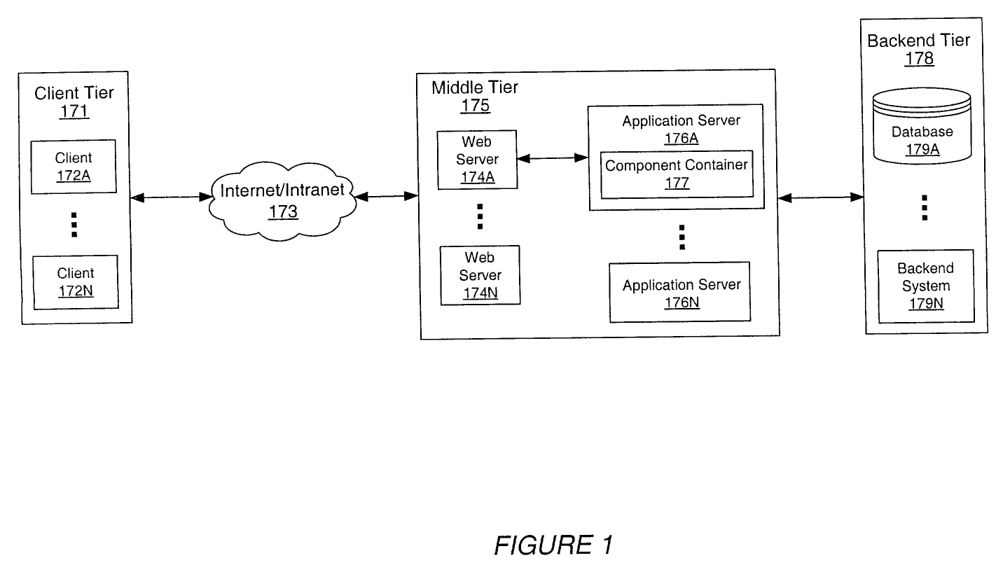

Suitable for implementing various embodiments, FIG. 1 illustrates a three-tier architecture of a computer system. The application logic of the computer system may be divided into application components (e.g., applets, servlets, server pages, beans, application clients, database objects) according to function and the various application components may be installed on different computers depending on factors such as security and load distribution. Tiers (e.g., client tier 171, middle tier 175, backend tier 178) may represent the logical or physical organization of the application components which may operate across one or more different computers. The different computers may be based on different platforms and architectures. In one embodiment, the application components of the computer system may be based on a three-tier architecture. In other embodiments, the application components of the computer system may be based on a two-tier or N-tier architecture. Thus, the application components of a computer system based on the three-tier architecture of FIG. 1 illustrate only one example of a computer system suitable for implementing various embodiments.

Client tier 171 may include a number of different clients 172A through 172N (e.g., device, system, user interface) communicating to application components (e.g., servlets, server pages, beans) in the middle tier 175 via the Internet/Intranet 173. The middle tier 175 may include a number of different Web servers 174A through 174N and/or application servers 176A through 176N. In some embodiments, an application server 176 may include functionality typically provided by a Web server 174. For example, functionality provided by a Web server 174 may be included in an application server 176 eliminating the need for the Web server 174. The backend tier 178 may include a number of different computer systems such as database 179A through backend system 179N.

Application components may communicate using different types of protocols such as Hyper Text Transfer Protocol Secure sockets (HTTPS), Java™ Database Connectivity (JDBC), Java Naming and Database Interface (JNDI), eXtensible Markup Language (XML) and/or Simple Object Access Protocol (SOAP). The application components within a tier typically communicate with remote application components in an adjacent tier. For example, multiple users with access to an application component configured to operate in a client tier 171 (e.g., application client accessible via a Web browser) may initiate requests (e.g., application program call) to each remote application component configured to operate in a middle tier 175. Each application component in the middle tier 175 may, in turn, initiate requests to the backend tier 178 on behalf of the application component in the client tier 171. For example, an application component in the middle tier 175 (e.g., bean) may receive a remote request from a Web browser operating in the client tier 171 and in response access an application component (e.g., database object) operating in the backend tier 178. The application component in the backend tier 178 may then provide a response to the application component in middle tier 175 which may complete the remote request.

Some of the application components operating within the middle tier 175 may be configured to run within a component container 177 provided with an application server 176A. Some standard services (e.g., security, transaction management, state management, multi-threading) may be built into a platform and provided automatically to the application components via the container 177 and/or application server 176A. The component container 177, for example, may be configured to provide concern-specific logic for some standard services to application components running within the component container 177. For example, component containers 177 may provide application programming interfaces for some common services that application components use to access the services.

Other concern-specific logic may not be provided by the component container 177. Other concern specific logic may be provided for by interception logic as described below.

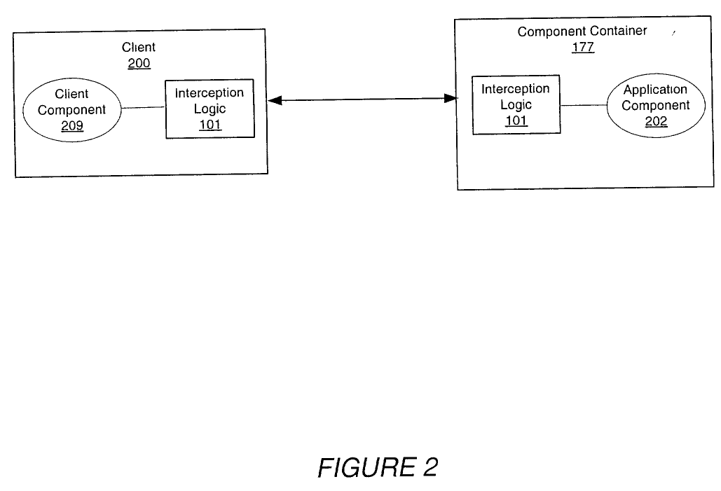

FIG. 2 illustrates one embodiment of interception logic 101 configured to intercept remote calls to an application component 202 and invoke concern-specific logic in response to an intercepted remote call to the application component 202. Additional concern-specific logic, such as concern-specific logic not supported as a standard by a component container 177, may be provided and accessed through interception logic 101. For example, concern-specific logic accessible through interception logic 101 and separate from an application component 202 may provide to the application component 202 one or more services not provided as a standard service of the component container 177.

Interception logic 101 may be configured to intercept each remote call from a client component 209 to an application component 202. In response to the intercepted remote call to the application component 202, interception logic 101 may invoke concern-specific logic on client-side 200, container-side 177 and/or both. Concern-specific logic may be specified and invoked on the client-side 200 and then the intercepted remote call (initial remote call) may be forwarded to interception logic 101 on the container-side 177. Concern-specific logic may be specified and then invoked on the container-side 177. The intercepted remote call to the application component 202 may then be made to the application component 202. The results of the remote call invocation may then be returned to the client component 209.

In some embodiments, implementing interception logic 101 may remove or alleviate the need of providing concern-specific logic into each application component 202. The concern-specific logic accessed through interception logic 101 may be configured to provide services such as entity-based access control, logging, method invocation recording and re-playing, exception handling, or other types of services. These services may not be provided as standard services of the component container 177. For example, the component container 177 may not provide authorization-based (entity access control) security for application components. Another concern-specific service provided through interception logic 101 may be to capture each method invocation in the form of a test script at run-time in order to replay the test script when testing each method with a simulated user. Other types of concern-specific logic provided through interception logic 101 may be recording and re-playing for function, subroutine, routine and/or procedure method invocations.

As described with FIG. 1, calls may be initiated from one or more application components (e.g., a client component 209) to one or more remote application components 202. A client component 209 may be any client of a computer system that initiates requests to an application component 202 and receives responses to the requests. For example, a client component 209 may be a dynamic Web page that relies on a Web server that generates Web pages using standard services provided by an application server. A client component 209 may include a Web browser (e.g., Internet Explorer or Netscape Navigator) that displays Web pages received from a Web and/or application server. In one embodiment, the client component 209 may be a dynamic Web page component developed with Java Server Pages or ASP.NET ™ in a Web server such as Apache, Sun Open Net Environment (ONE) Application Server™ or Microsoft Internet Information Server (IIS)™.

In one embodiment, the application component 202 whose remote calls may be intercepted may be a bean such as an Enterprise JavaBeans™ (EJB™) and the bean may run within the component container 177. The application component 202 and/or concern-specific logic may be developed using various frameworks such as Java™ 2 Platform, Enterprise Edition (J2EE™) from Sun Microsystems, Core Services Framework (CSP) from Hewlett Packard, Sun™ ONE Framework from Sun Microsystems, .NET Framework from Microsoft or some other framework. An integrated development environment (e.g., Microsoft Visual Studio .NET, open source NetBeans, Sun™ ONE Studio) may be used to automatically generate some or all of the application component 202 and/or concern-specific logic.

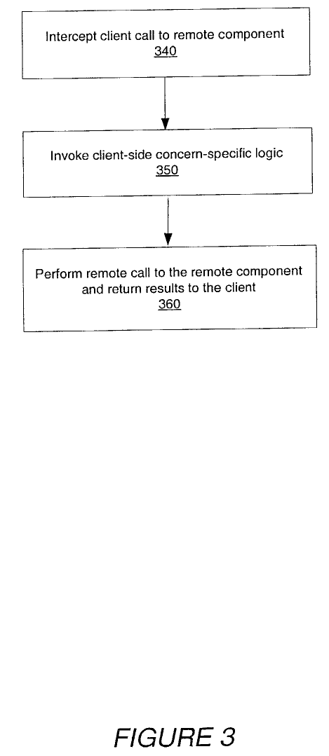

FIG. 3 shows a flowchart of one embodiment of a method for intercepting remote calls to an application component and invoking concern-specific logic on the client-side in response to an intercepted remote call to the application component. Additional concern-specific logic may be provided and accessed on the client-side as described with FIG. 2. Calls may be initiated from one or more client components (e.g., client of a computer system that initiates requests to an application component) to one or more remote application components.

Each remote call from a client component to an application component may be intercepted, as indicated in 340. In one embodiment, the application component whose remote calls may be intercepted may be beans developed with Enterprise JavaBeans™ (EJB™). Each call may be intercepted by a client-side proxy for a remote interface of the application component. In response to the intercepted remote call to the application component, concern-specific logic may be invoked on the client-side, as indicated in 350. Thus, concern-specific logic may be applied or initiated before each remote call is received at the application component container. The intercepted remote call may then be forwarded to the container-side and invoked as if the initial remote call was not intercepted, as indicated in 360. The results of invoking the initial remote call may then be returned to the client component.

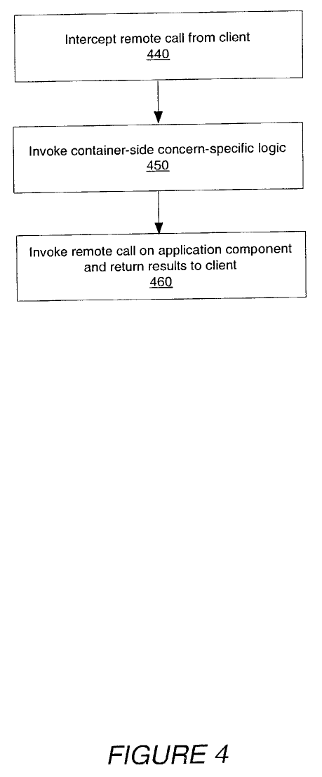

FIG. 4 shows a flowchart of one embodiment of a method for intercepting remote calls to an application component and invoking concern-specific logic on the container-side in response to an intercepted remote call to the application component. Similar to the embodiment of the method described in FIG. 3, concern-specific logic, such as concern-specific logic not supported as a standard by the component container, may be provided and accessed on the container-side.

Each remote call from a client component to an application component may be intercepted, as indicated in 440. The remote call may be intercepted by a container-side proxy for the application component. The proxy may determine if container-side concern-specific logic should be invoked in response to the intercepted call. If so, container-side concern-specific logic is invoked. Thus, concern-specific logic may be included after each intercepted remote call is received at the container-side, as indicated in 450. The intercepted remote call may then be invoked as if the initial remote call was not intercepted, as indicated in 460. The results of invoking the initial remote call may be returned to the client component.

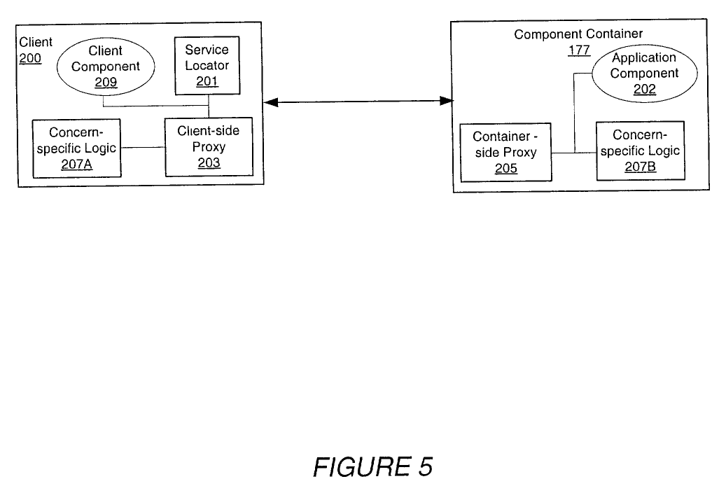

FIG. 5 illustrates one embodiment of interception logic including a service locator 201, a client-side proxy 203 and a container-side proxy 205. The service locator 201 may be configured to locate a remote interface of the application component 202 for use by a client to remotely access the application component. In response to a request from a client component 209, the service locator 201 may return a client-side proxy 203 that includes a remote interface to access the application component 202. The client-side proxy 203 may also be configured to provide for invoking concern-specific logic. The client-side proxy 203 may be configured to receive remote calls made by client component 209 to the application component 202. The client-side proxy 203 may determine whether or not to invoke client-side concern-specific logic 207A in response to the remote call. If client-side concern-specific logic 207A is provided, it may be invoked by client-side proxy 203 (e.g. to log the remote call). The client-side proxy 203 may forward the remote call to container-side proxy 205. Thus, container-side proxy 205 may “intercept” the remote call when it receives the remote call from the client-side proxy, in one embodiment. The container-side proxy 205 may determine whether or not to invoke container-side concern-specific logic 207B in response to the remote call. If container-side concern-specific logic 207B is provided, it may be invoked by container-side proxy 205 (e.g., to authenticate the client). The container-side proxy 205 may forward the remote call to the application component 202 for performance of the remote call. Any results may be returned to the client.

In one embodiment, to provide a container-independent approach, the service locator 201 may be configured separate from the component container 177. The service locator 201 may also be implemented as part of the component container 177 in other embodiments.

In one embodiment, implemented based on a service locator pattern, the service locator 201 may be configured to locate the remote interface of the application component 202 in response to an initial remote call from the client component 209 to the service locator 201. In other embodiments, the service locator may be implemented as part of a naming and directory service. The service locator returns a client-side proxy 203 to the client component 209. In one embodiment, the client-side proxy 203 may be lo configured from a class, instantiated on the client-side and configured to maintain a remote reference to the application component 202. The client-side proxy 203 may implement a remote interface of the application component 202 and forward remote calls to the container-side.

The service locator 201 may be configured to locate the remote interface instead of the client component 209 directly locating the remote interface from a directory and naming service. By having the client make requests for access to application components through the service locator, a client-side proxy may be returned that includes a remote interface to the requested application component. Returning a client-side proxy instead of just the remote interface allows remote calls to be “intercepted” for concern-specific logic.

In one embodiment, the client-side proxy 203 may maintain a separate proxy object for providing access to business application methods of the application component 202. For example, the client-side proxy 203 may intercept each instantiation method (e.g., a create method) of an application component 202 and create a separate proxy object to implement the corresponding business application methods. In one embodiment, the client-side proxy 203 may be implemented using the java.lang.reflect.Proxy class of the Java Development Kit (JDK) from Sun Microsystems, Inc. The client-side proxy 203 may also be configured to do more than forward remote calls to the container-side. For example, in one embodiment, the client-side proxy 203 may be configured to locally cache state information for the application component 202 to avoid network overhead on each method call.

In one embodiment, the interception logic 101 may be configured to create a container-side proxy 205. For example, when the client-side proxy 203 intercepts an instantiation method (e.g., a create method) of an application component 202, the container-side proxy 205 may be instantiated in the component container 177. In one embodiment, the container-side proxy 205 may be configured from a class, instantiated on the container-side and configured to maintain a container-side remote reference to the application component 202. This instance of the container-side proxy 205 may be cached, and a reference to the container-side proxy 205 generated and returned to the client-side proxy 203. The container-side proxy remote reference to the application component 202 may be stored and maintained by the client-side proxy 203. The container-side proxy 205 may be configured to invoke concern-specific logic included on the container-side 177. In one embodiment, the container-side proxy 205 may be implemented using a single stateless (or stateful) session bean.

The client-side proxy 203 may intercept each remote call to the application component 202 that originates from the client component 209. In one embodiment, the client-side proxy 203 may be configured to determine if concern-specific logic has been included on the client-side. In response to the intercepted remote call to the application component, concern-specific logic may then be invoked on the client-side. For example, in one embodiment, the client-side proxy 203 may invoke the client-side concern-specific logic 207A in response to an intercepted call and forward the intercepted remote call to the container-side proxy 205. In one embodiment, requests from client component 209 may be forwarded from client-side proxy 203 to container-side proxy 205 using a serializable “method call” object, including information on the application component 202 being accessed, request type (e.g. method name) and request parameters. In one embodiment, the container-side proxy 205 may be configured to determine if concern-specific logic has been included on the container-side. The container-side proxy 205 may then invoke the container-side concern-specific logic 207B. Thus, instead of configuring each application component 202 of a computer system to include the concern-specific logic 207, the concern-specific logic 207 may be as separate common concern logic and invoked in response to intercepted remote calls. Client-side and/or container-side proxies may be established for a plurality of client and application components to provide access to the common client-side or container-side concern-specific logic without having to include the concern-specific logic in each client or application component. In some embodiments, the client or application components may not even be aware of the proxies and/or concern-specific logic.

Via a client-side proxy 203 and container-side proxy 205, control of where the concern-specific logic is executed (e.g., the client-side 207A and/or the container-side 207B) may be provided. Each of the one or more remote calls to the application component 202 may be intercepted both on the client-side via the client-side proxy 203 and on the container-side via the container-side proxy 205. Concern-specific logic may be specified for client-side execution 207A and/or container-side execution 207B.

After invoking concern-specific logic 207B, the container-side proxy 205 may invoke the remote call to the application component 202 and any results may be forwarded to the client component 209. Appropriate exceptions may be generated that may prevent the remote call from being invoked. In one embodiment, the result of the call to application component 202 may be forwarded from container-side proxy 205 to client-side proxy 203 using a serializable “method result” object, including information on the method result and exception thrown, if any.

In one embodiment, concern-specific logic component 207B may be registered in an application server as a method invocation listener. For example, when a method invocation is received by container-side proxy 205 for application component 202, prior to forwarding the method invocation to the application component, it may be sent to concern-specific logic component 207B. In one embodiment, concern-specific logic 207B may provide access control logic. By using the interception logic described herein, every method invocation, prior to forwarding to an application component, will be sent to the access control concern-specific logic. If any access control rules are violated, the concern-specific logic may throw an appropriate exception and prevent the remote call from being executed. The client may receive a security exception. If access is permitted, the remote call may be forwarded to the application component and executed as normal. Thus, access control logic may be provided for multiple application components without the client or application server container being aware of the interception logic (e.g. proxy framework) and concern-specific logic.

In one embodiment, various concern-specific logic services may be included in the interception logic. Concern-specific logic may be configured to provide services such as entity-based access control, logging, method invocation recording and re-playing, exception handling or other types of services not provided as a standard service of the component container 177. By registering concern-specific logic as event listeners on the client-side and/or container-side to intercept remote calls received by the proxy framework, concern-specific logic services may be invoked on either the client-side and/or the container-side.

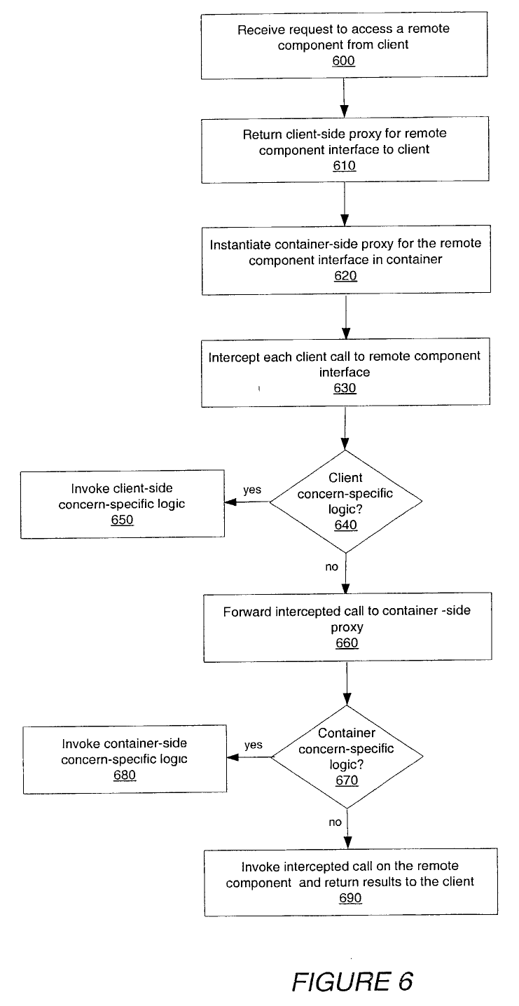

FIG. 6 shows a flowchart of one embodiment of a method for intercepting remote calls to an application component and invoking concern-specific logic in response to an intercepted remote call to the application component. The concern-specific logic may be configured to provide a service that is not included as a standard service of a component container. The concern-specific logic and the application component may be configured to run within a component container. The following method is exemplary. Other variations may be performed by various embodiments of methods for intercepting remote calls to an application component and invoking concern-specific logic in response to an intercepted remote call to the application component.

In one embodiment, a service locator may receive a call from a client component to access a remote application component, as indicated in 600. In one embodiment, instead of a client component directly locating a remote interface to the application component, the client calls the service locator to locate the remote interface. For example, in response to a remote call from a client component for access to the application component, the service locator may locate a remote interface of the application component. A client-side proxy that implements the application component remote home interface may then be instantiated and returned to the client component, as indicated in 610. The client-side proxy may appear to the client as the actual remote home interface. Thus, subsequent remote calls to the application component may then be received by the client-side proxy.

In one embodiment, a container-side proxy may be created. For example, when the client-side proxy intercepts an instantiation method (e.g., a create method) of an application component, the container-side proxy may be instantiated by the component container, as indicated in 620. The container-side remote reference to the application component may be stored and maintained by the container-side proxy. Concern-specific logic included on the container-side may be invoked from the container-side proxy.

Each remote call that originates from the client component to the application component may be received by the client-side proxy, as indicated in 630. In one embodiment, the client-side proxy may determine if concern-specific logic has been included on the client-side and should be invoked, as indicated in 640. In one embodiment, the client-side concern-specific logic may intercept the remote calls received by the client-side proxy as a listener. In response to the intercepted remote call to the application component, concern-specific logic may then be invoked on the client-side, as indicated in 650. The intercepted remote call may then be forwarded to the container-side proxy 205, as indicated in 660. In one embodiment, the container-side proxy may determine if concern-specific logic has been included on the container-side and should be invoked or the container-side concern-specific logic may be a listener for remote calls received at the container-side proxy, as indicated in 670. The container-side concern-specific logic may then be invoked on the container-side, as indicated in 680. Thus, concern-specific logic may be included on the client-side as each remote call is forwarded by the client-side proxy to the container-side proxy and/or on the container-side as each remote call is received by the container-side proxy.

After invoking concern-specific logic on the container-side, the remote call may be invoked as if the original remote call was not intercepted, as indicated in 690. Results of the method invocation may then be forwarded to the client component. Appropriate exceptions may be generated that may prevent the original remote call from being invoked. In one embodiment, exceptions may be propagated normally through the proxies such that the client-side proxy receives a remote exception wrapping the actual exception. In another embodiment, the exception may be captured by the container-side proxy and returned as a part of the results to the client component. The client-side proxy may then “re-throw” the actual exception to the client. In this embodiment, other information may also be returned in the results with the exception. For example, a container-side proxy reference for a call that resulted in an exception may be returned with the exception to the client.

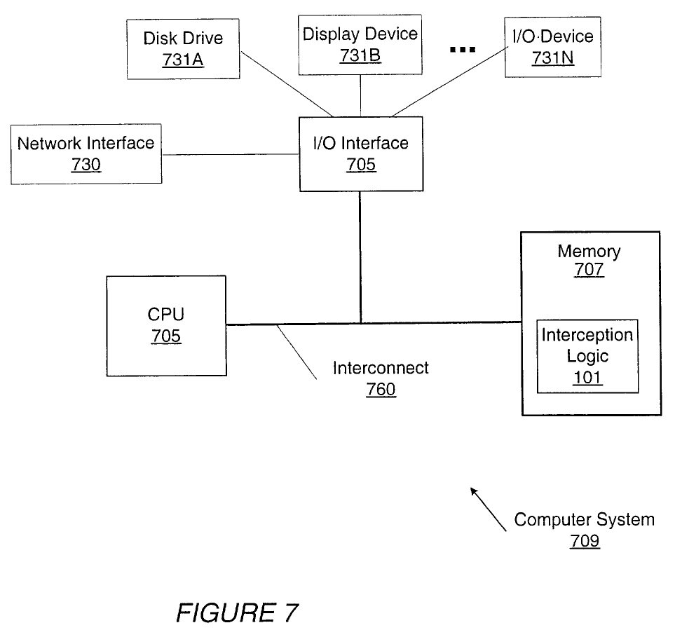

FIG. 7 illustrates a computer system 709 that may include one embodiment of interception logic 101 configured to intercept remote calls to an application component and invoke concern-specific logic in response to an intercepted remote call to the application component. As described with FIGS. 1 and 2, each remote application component may execute on a separate platform from a client component. Computer system 709 may be a system on which the container and application components are provided, or computer system 709 may be a system on which the client is running.

Computer system 709 may include many different components such as memory 707, a central processing unit (CPU) or processor 706, an input/output (I/O) interface 705 and device interconnect 750. Interconnect 750 is relied upon to communicate data from one component to another. For example, interconnect 750 may be a point-to-point interconnect, a shared bus, a combination of point-to-point interconnects and one or more buses, and/or a bus hierarchy including a system bus, CPU bus, memory bus and I/O buses such as a peripheral component interconnect (PCI) bus. Memory 707 may store program instructions accessed by the CPU 706. For example, instructions and data implementing interception logic 101 may be stored in memory 707.

Computer system 709 may further include other software and hardware components, such as a network interface 730, that may be coupled to various other components and memory 707. The CPU 706 may acquire instructions and/or data through the I/O interface 705. Through the I/O interface 705, the CPU 706 may also be coupled to one or more other components 731. As illustrated, components 731 may include disk drive 731A, a display device 731B and other I/O devices 731C for use with computer system 709 such as other CPUs, track balls, mice, keyboards, printers, plotters, scanners, etc. Some computer systems 709 may include additional and/or other components than shown in FIG. 7.

In one embodiment, interception logic 101 may be configured within an application server. The application server may provide system-level services to application components that operate across different computers based on different platforms and architectures. According to one embodiment, the application components may be implemented on virtual machines (VMs) (e.g., Java Virtual Machines) coupled to interception logic 101. In one embodiment, the client-side application components may be implemented on virtual machines (VMs) (e.g., Java Virtual Machines). The virtual machines may be implemented on one or more computers 709. Interception logic 101 may operate on different and various types of computers that may communicate to each other over a network. For example, a client may operate on a desktop computer running Windows™ NT from Microsoft and an application server, in one embodiment, may operate on a minicomputer running an operating system such as Sun™ Linux from Sun Microsystems.

The flow charts described herein represent exemplary embodiments of methods. The methods may be implemented in software, hardware, or a combination thereof. The order of method may be changed, and various elements may be added, reordered, combined, omitted, modified, etc.

Various modifications and changes may be made to the invention as would be obvious to a person skilled in the art having the benefit of this disclosure. It is intended that the following claims be interpreted to embrace all such modifications and changes and, accordingly, the specifications and drawings are to be regarded in an illustrative rather than a restrictive sense.

Various embodiments may further include receiving, sending or storing instructions and/or data implemented in accordance with the foregoing description upon a computer readable medium. Generally speaking, a computer readable medium may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link.

What is claimed is:

1. A system, comprising:
an application component configured to run within a component container, wherein the component container is configured to provide standard services to application components;
a container-side proxy for the application component, wherein the container-side proxy is configured to run within the component container; and
concern-specific logic configured to provide a service that is not included as a standard service of the component container, wherein the concern-specific logic is separate from the application component;
wherein the container-side proxy for the application component is configured to receive one or more remote calls to the application component for interception by the concern-specific logic.

2. The system as recited in claim 1, further comprising:
a client component configured to originate remote calls to the application component;
client-side concern-specific logic;
a client-side proxy configured to:
receive one or more of the remote calls originated by the client component for interception by the client-side concern-specific logic;
forward the one or more remote calls to the container-side proxy.

3. The system as recited in claim 2, wherein the client-side proxy is further configured to maintain a remote reference to the application component, wherein the client-side proxy appears to the client component as the remote interface of the application component.

4. The system as recited in claim 2, further comprising a service locator, wherein the service locator is configured to return the client-side proxy to the client component in response to a call from the client component for a remote interface to the application component.

5. The system as recited in claim 2, wherein the client component executes on a Java Virtual Machine and the application component executes on a different Java Virtual Machine than the client component.

6. The system as recited in claim 1, wherein the container-side proxy is further configured to forward the remote calls to the application component.

7. The system as recited in claim 1, wherein the component container is an Enterprise JavaBeans component container and the application component is developed as an Enterprise JavaBean.

8. The system as recited in claim 7, wherein the concern-specific logic is registered as a method invocation listener to receive remote method invocations for the application component.

9. The system as recited in claim 8, wherein the concern-specific logic is configured to provide authorization-based access control for the application component and to generate an exception if any access control rules are violated.

10. A method, comprising:
creating a container-side proxy for an application component, wherein the container-side proxy and the application component run within a component container that provides standard services to application components;
the container-side proxy receiving one or more remote calls to the application component for interception by concern-specific logic; and
wherein the concern-specific logic provides a service that is not included as a standard service of the component container, wherein the concern-specific logic is separate from the application component.

11. The method as recited in claim 10, further comprising:
receiving a request from a client component to remotely access the application component;
returning a client-side proxy in response to the request;
the client-side proxy receiving one or more remote calls to the application component originated by the client component;
invoking client-side concern-specific logic in response to one or more of the remote calls received by the client-side proxy; and
the client-side proxy forwarding the one or more remote calls to the container-side proxy.

12. The method as recited in claim 11, wherein said receiving comprises a service locator receiving the request from the client instead of a directory and naming service of the component container.

13. The method as recited in claim 11, wherein the client component executes on a Java Virtual Machine and the application component executes on a different Java Virtual Machine than the client component.

14. The method as recited in claim 10, wherein the component container is an Enterprise JavaBeans component container and the application component is developed as an Enterprise JavaBean.

15. The method as recited in claim 10, wherein the concern-specific logic is registered as a method invocation listener to receive each call to one or more methods of the application component received by the container-side proxy.

16. The method as recited in claim 10, wherein the concern-specific logic component provides authorization-based access control for the application component and generates an appropriate exception if any access control rules are violated.

17. A computer accessible medium comprising program instructions, wherein the program instructions are executable to implement:
creating a container-side proxy for an application component, wherein the container-side proxy and the application component run within a component container that provides standard services to application components;
the container-side proxy receiving one or more remote calls to the application component for interception by concern-specific logic; and
wherein the concern-specific logic provides a service that is not included as a standard service of the component container, wherein the concern-specific logic is separate from the application component.

18. The computer accessible medium as recited in claim 17, wherein the program instructions are further executable to implement:
receiving a request from a client component to remotely access the application component;
returning a client-side proxy in response to the request;
the client-side proxy receiving one or more remote calls to the application component originated by the client component;
invoking client-side concern-specific logic in response to one or more of the remote calls received by the client-side proxy; and
the client-side proxy forwarding the one or more remote calls to the container-side proxy.

19. The computer accessible medium as recited in claim 18, wherein said receiving comprises a service locator receiving the request from the client instead of a directory and naming service of the component container.

20. The computer accessible medium as recited in claim 18, wherein the client component executes on a Java Virtual Machine and the application component executes on a different Java Virtual Machine than the client component.

21. The computer accessible medium as recited in claim 17, wherein the component container is an Enterprise JavaBeans component container and the application component is developed as an Enterprise JavaBean.

22. The computer accessible medium as recited in claim 17, wherein the concern-specific logic is registered as a method invocation listener to receive each call to one or more methods of the application component received by the container-side proxy.

23. The computer accessible medium as recited in claim 17, wherein the concern-specific logic component provides authorization-based access control for the application component and generates an appropriate exception if any access control rules are violated.
